(19) United States
(12) Patent Application Publication
(10) Pub. No.: US 2017/0193413 A1
(43) Pub. Date: Jul. 6, 2017

(54) PREDICTIVE UTILIZATION OF RESOURCES AND ALARM SYSTEM

(71) Applicant: BANK OF AMERICA CORPORATION, Charlotte, NC (US)

(72) Inventors: Kevin T. Cole, Charlotte, NC (US); Matthew Hsieh, Charlotte, NC (US); Scott R. Enscoe, Charlotte, NC (US); Caitlin Chrisman Bullock, Durham, NC (US)

(21) Appl. No.: 14/986,996

(22) Filed: Jan. 4, 2016

(51) Int. Cl. G06Q 10/06; G06F 21/31; G06F 21/62

(52) U.S. Cl. CPC G06Q 10/06313; G06F 21/6218; G06F 21/31

(57) ABSTRACT

Embodiments of the invention are directed to a system, method, or computer program product for providing a predictive utilization of resource and daily resource goal progression interface. In this way, the invention provides a real-time daily interface presentation on a mobile device. The system gains access to one or more resources of a user and compiles the resources into an interface for resource visualization. The system subsequently manipulates the real-time resource data to project resource goal progression and maturation. Furthermore, the system analysis resource allocation and presents temporal peak graphical representations of fluctuations in resource allocation across time frames.

### BACKGROUND

Advancements in technology have made mobile devices with multi-faceted functionality available to large numbers of individuals. With the continued addition of new functions to these mobile devices, requirements for resource availability presentation and interface interactions is desired.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for providing a predictive utilization of resource and alarms associated with the same.

In some embodiments, the system may generate a tool that determines goals associated with user resources and provides daily goals for the user and informs the user of progress towards the goals. For example, if the user needs X.XX dollars to reach a goal that day, the system application may generate an alert and suggestions for meeting the goal for the day.

In some embodiments, the system may identify recurring expenses, such as scheduled payments associated with user resources, and account for these recurring expenses when determining goals of the user. Furthermore, the invention may identify fluctuations in resource allocation over a time period, such as month to month or year to year, the invention may transform the identified fluctuations and generate a temporal peaked display of the fluctuations onto a user device. In some embodiments, the system may be able to utilize the goal data to budget yearly resource expenses. Along with the current goals and yearly resource expenses the system may project future goals and expenditure for the user.

Finally, in some embodiments, the invention may predict spend patterns for resources with respect to a particular payment vehicle and allocate resources to ensure that savings will allow for payment of the vehicle at the end of a period.

Embodiments of the invention relate to systems, methods, and computer program products for predictive utilization of resources, the invention comprising: determining resources available to a user; receiving authorization credentials from the user to access the resources; extracting resource data from a source of each resource available to the user, wherein the resource data includes historic resource allocation, real-time resource balances, and recurring expenses for the resources; converting the extracted resource data into a textual format encrypted for implementation on an interface; determining resource goals for the user based on the extracted resource data and user input data; identifying fluctuations in resource allocation based on the extracted resource data and generate a temporal peak visualization representation of the fluctuations; projecting, based on the historic resource allocation, the real-time resource balances, and the recurring expenses for the resources, resource savings, and goal maturation points; generating the interface for presenting daily goal progression; and presenting, at a predetermined time each day, the interface, wherein the interface presents goal progression, a graphical representation of the fluctuations via the temporal peak visualization representation, the projected resource savings, and the projected goal maturation.

In some embodiments, the invention further comprises generating a payment vehicle level resource allocation directive for a future time period based on the resource goals relative to the recurring expenses and real-time resource balances.

In some embodiments, identifying fluctuations in resource allocation based on the extracted resource data further comprises identifying differences between a historic resource allocation to an entity and a current resource allocation to the entity within a month to month or year to year time frame.

In some embodiments, presenting the interface further comprises presenting the interface via an overlay on a screen of the mobile device such that the interface displaces one or more portions of a session on the display, whereby manipulating the physical position of the displaying of the session. In some embodiments, the one or more portions of a session on the display further comprises a web session, text session, or telephone session of the user on the mobile device.

In some embodiments, converting the extracted resource data into a textual format encrypted for use on the interface further includes preventing the data from being readable in any medium other than the interface if data is removed from the interactive forecast interface.

In some embodiments, the resources comprise financial resources of the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a predictive utilization of resource system environment, in accordance with one embodiment of the present invention;

FIG. 2 provides a high level process flow illustrating the predictive utilization of resource process, in accordance with one embodiment of the present invention;

FIG. 3 provides a process map illustrating the real-time determination of resource availability process, in accordance with one embodiment of the present invention; and

FIG. 4 provides a process map illustrating the real-time determination of resource availability process, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, as used herein the term “user device” or “mobile device” may refer to mobile phones, personal computing devices, tablet computers, wearable devices, and/or any portable electronic device capable of receiving and/or storing data therein.

An “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Resources” include accounts of the user and/or other property owned by the user. The resources may be associated with accounts or may be property that is not associated with a specific account. Examples of resources associated with accounts may be accounts that have cash or cash equivalents, or accounts that are funded with or contain property, such as safety despots box account that jewelry, a trust account that is funded with property, or the like. Examples of resources that may not be associated with accounts may be antiques in a user's home, jewelry in a user's home, or the like. “Funds” or “Available Balance” are a balance in an account that can be invested or withdrawn. For example, the funds may refer to a bank ledger balance minus the amount of any monetary checks in the process of collection. Funds may also be referred to as an available balance, a collected balance, good funds, and usable funds.

Inflows refer to funds received from or deposited into the user's resources (e.g., user's accounts, or the like), such as paychecks, 401K disbursements, pension disbursements, rental property, or the like. Outflows refer to funds outgoing from the user's resources (e.g., user's accounts, or the like) to cover liabilities, such as payments for housing (e.g., rent or mortgage), bills, health care insurance and other costs, heat, water, food, car, boat, transportation, or like, which illustrates all of the essential (e.g., necessary or semi-necessary to the user) costs that cover what the user currently uses to live. A “payment” is a monetary amount or item of monetary value transferred from one individual or entity to another individual or entity in return for receipt of good(s) and/or services.

A “transaction” refers to any communication between a user and the financial institution or other entity monitoring the user's activities. For example, a transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

A “user” may be a financial institution user (e.g., an account holder or a person who have an account (e.g., banking account, credit account, or the like)). In one aspect, a user may be any financial institution user involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “user” may be used interchangeably.

Embodiments of the present invention address the above needs and/or achieve other advantages by providing apparatuses (e.g., a system, computer program product and/or other devices) and methods for providing a real-time predictive utilization of resources including an alert system. In this way, the invention provides a real-time daily projection of goal progression regarding resources via an overlayable interface on a mobile device.

Embodiments of the present invention address the above needs and/or achieve other advantages by providing apparatuses (e.g., a system, computer program product and/or other devices) and methods for providing a predictive utilization of resource and alarms associated with the same.

In some embodiments, the system may generate a tool that determines goals associated with user resources and provides daily goals for the user and informs the user of progress towards the goals. For example, if the user needs X.XX dollars to reach a goal that day, the system application may generate an alert and suggestions for meeting the goal for the day.

In some embodiments, the system may identify recurring expenses, such as scheduled payments associated with user resources, and account for these recurring expenses when determining goals of the user. Furthermore, the invention may identify fluctuations in resource allocation over a time period, such as month to month or year to year, the invention may transform the identified fluctuations and generate a temporal peaked display of the fluctuations onto a user device. In some embodiments, the system may be able to utilize the goal data to budget yearly resource expenses. Along with the current goals and yearly resource expenses the system may project future goals and expenditure for the user.

Finally, in some embodiments, the invention may predict spend patterns for resources with respect to a particular payment vehicle and allocate resources to ensure that savings will allow for payment of the vehicle at the end of a period.

Embodiments of the invention are directed to a system, method, or computer program product for a distributive network system with specialized data feeds associated with the distributive network and specific triggering events associated with the data feeds for real-time predictive goal presentation for user resources including predictive utilization of resources and alarms. In this way, the invention may code and overlay an interface and associated dashboard onto a displaying mobile device. Thus, the system may communicate with, store, and execute code on a mobile device for completion of overlay and presentation of the interface. Furthermore, the system may manipulate and transform currently stored applications on a user device for overlay of the interface.

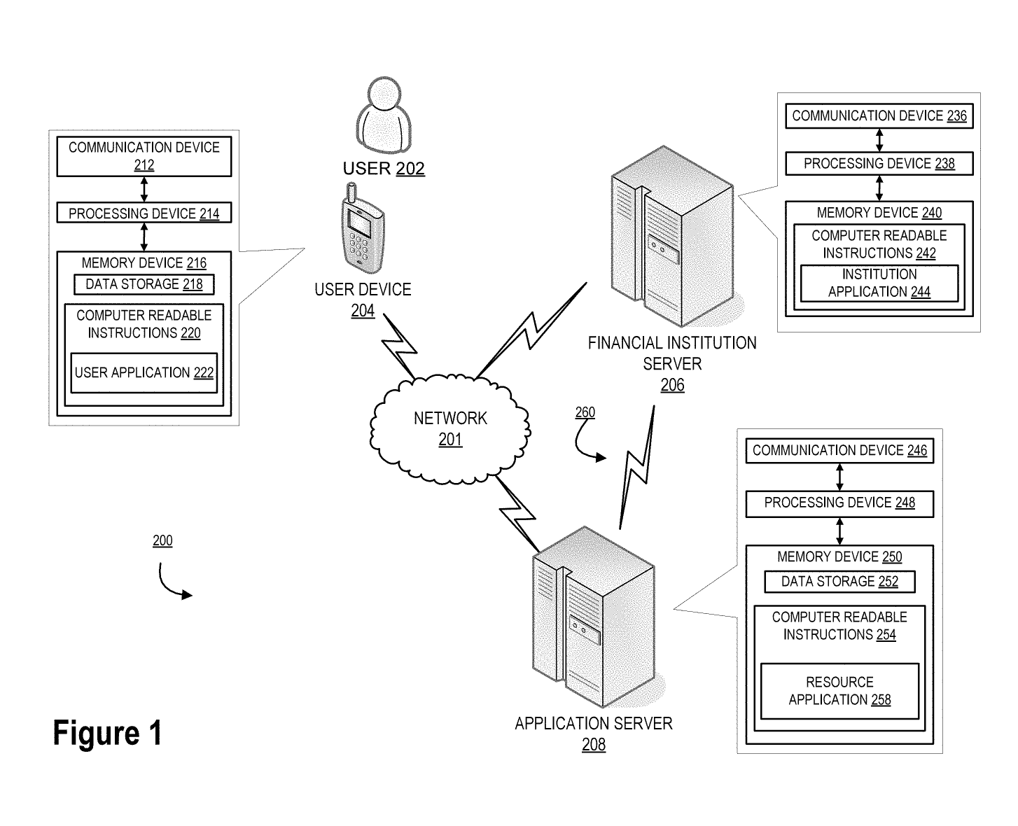

FIG. 1 illustrates a predictive utilization of resource system environment 200, in accordance with one embodiment of the present invention. FIG. 1 provides the system environment 200 for which the distributive network system with specialized data feeds associated with the predictive utilization of resource and alert determination and subsequent interjection of an interactive interface onto a user device with specialized feeds for resource availability manipulation and visualization.

FIG. 1 provides a unique system that includes specialized servers and system communicably linked across a distributive network of nodes required to perform the functions of providing a predictive utilization of resource and alarm visualization interface. Furthermore, the invention presents an interface that may appear via overlay on a mobile device screen such as during a web session, texting session, telephone session, gaming session, or the like being conducted on the mobile device. Thus, the interface may displace one or more portions of the web session on the display, as such manipulating the physical position of the displaying of the web session, text session, telephone session or the like such that the interface maybe displayed and visualized as an overlay.

As illustrated in FIG. 1, the application server 208 is operatively coupled, via a network 201 to the user system 204, and to the financial institution server 206. In this way, the application server 208 can send information to and receive information from the user device 204 and the financial institution server 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that has a user device, such as a mobile phone, tablet, or the like. FIG. 1 also illustrates a user system 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The user device 204 is a computing system that provide authentication for resource viewing and for goal review via the interface. The processing device 214 is operatively coupled to the communication device 212 and the memory device 216. The processing device 214 uses the communication device 212 to communicate with the network 201 and other devices on the network 201, such as, but not limited to the financial institution server 206 and the application server 208. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222.

In some embodiments, the user application 222 allows a user 202 to provide authentication for resource viewing and for viewing of a daily goal progress presentation interface via the user device 204. Furthermore, the interface may provide the user 202 with resource budgeting and allocation and presentation of projected allocation of resources. In some embodiments, the user application 222 allows the user to sign onto or authenticate into the interface. In this way, the user application 222 may allow the user access to the interface via authentication. Authentication into the interface may require at least one authentication into one or more of the resources. In this way, if a user has a checking account, the user application 222 may accept authentication into the checking account as an acceptable authentication into the interface. The user application 222 based on communication from the application server 208 may randomly require the user to authenticate into the forecast interface by requesting a random resource account authentication credential to access the interface.

As further illustrated in FIG. 1, the application server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the financial institution server 206 and the user system 204. As such, the communication device 246 generally comprises a modem, server, or other device for communicating with other devices on the network 201.

As further illustrated in FIG. 1, the application server 208 comprises computer-readable instructions 254 stored in the memory device 250, which in one embodiment includes the computer-readable instructions 254 of a resource application 258. In some embodiments, the memory device 250 includes data storage 252 for storing data related to the system environment, but not limited to data created and/or used by the resource application 258.

In the embodiment illustrated in FIG. 1 and described throughout much of this specification, the resource application 258 may determine resource balances and recurring schedules in resource allocation, determine user goals, identify fluctuations in resource allocation, project resource allocation and goal maturation, and generating and displaying an interface associated with predictive utilization of resources.

In some embodiments, the resource application 258 may determine resource balances and recurring schedules in resource allocation. In this way, the resource application 258 may communicate with the financial institution server 206, the user device 204, and merchants to identify resources the user 202 may have. Furthermore, the resource application 258 may contact merchants to identify scheduled recurring payments that the user may have with one or more merchants, individuals, or the like.

In some embodiments, the resource application 258 may determine user goals. In some embodiments, determining goals includes the resource application 258 receiving and identifying savings and/or spending goals that a user 202 may implement. In some embodiments, the resource application 258 may receive goals in the way of products and/or services that the user 202 may wish to purchase and a time frame associated with that purchase. In other embodiments, the resource application 258 may identify goal purchases for a user 202 based on user historical purchases, user social media interactions, or the like.

In some embodiments, the resource application 258 may identify fluctuations in resource allocation. In this way, the resource application 258 may identify fluctuations in spending of resources within a time period, such as from day to day, month to month, year to year, or the like. The fluctuations may be any discrepancies in resource allocation from one time point to another, these may include small discrepancies in resource amount. Furthermore, the resource application 258 may be able to identify when fluctuations include the movement of resources from one account to another or from one form to another, and not contribute those loss or gains in resources, thus account for the fluctuation and not include the fluctuations in the generated temporal peak visualization presentation on the interface.

In some embodiments, the resource application 258 may incorporate any changes in resource levels for each individual account and generate a temporal peak within a graphical representation for user visualization of changes in resources over a given time period.

In some embodiments, the resource application 258 may project resource allocation and goal maturation. In this way, the resource application 258 may analyze and review the resources collected. The review of this data provides an indication of current savings of the user 202. Furthermore, based on resource allocation or lack of resource allocation to particular items, such as houses, cars, or the like may provide the resource application 258 with a predicted goal that the user 202 may be saving for. In some embodiments, the resource application 258 may receive savings goals from the user 202. In some embodiments, the resource application 258 may generate projected savings goals for the user based on age, current resource allocation, and the like.

In some embodiments, the resource application 258 may generating and displaying an interface associated with predictive utilization of resources. The generated interface may comprise a daily goal progress indication, a link for communication between the user 202 and other individuals for support and/or advice with respect to the daily goal progress report, a resource application 258 generated temporal peak visualization of identified fluctuations in resource allocation, the resource application 258 generated projected resource allocation, the resource application 258 generated projected resource savings, the resource application 258 generated projected goal maturation for resources, and/or the resource application 258 generated payment vehicle level resource allocation.

The resource application 258 may display a goal progress report via an interactive interface. The display is presented, in some embodiments, as an overlay over an already displaying mobile device display. Furthermore, the resource application 258 may convert data extracted from the sources into a structured format for monitoring and implementation into the forecast. In this way, the data may be converted into a textual format encrypted for security use for only the interface. Once the data is removed from the interface, the resource application 258 encryption may prevent the data from being readable in any other medium.

In some embodiments, the resource application 258 may present the interface onto the user device 204 at a predetermined time each day. In this way, the resource application 258 may be presented via overlay on the user device 204 screen such as during a web session, texting session, telephone session, gaming session, or the like being conducted on the user device 204. Thus, the interface may displace one or more portions of the web session on the display, as such manipulating the physical position of the displaying of the web session, text session, telephone session or the like such that the dashboard may be displayed and visualized as an overlay.

As illustrated in FIG. 1, the financial institution server 206 is connected to the application server 208 and is associated with a financial institution network. In this way, while only one financial institution server 206 is illustrated in FIG. 1, it is understood that multiple network systems may make up the system environment 200. The financial institution server 206 generally comprises a communication device 236, a processing device 238, and a memory device 240. The financial institution server 206 comprises computer-readable instructions 242 stored in the memory device 240, which in one embodiment includes the computer-readable instructions 242 of an institution application 244. The financial institution server 206 may communicate with the application server 208 to provide authentication credentials for resources and provide up to date real-time resource status information. While the application server 208 may communicate with the financial institution server 206 via a secure connection 260 generated for secure encrypted communications between the two systems for manipulating and transferring funds to one or more different resources.

It is understood that the servers, systems, and devices described herein illustrate one embodiment of the invention. It is further understood that one or more of the servers, systems, and devices can be combined in other embodiments and still function in the same or similar way as the embodiments described herein.

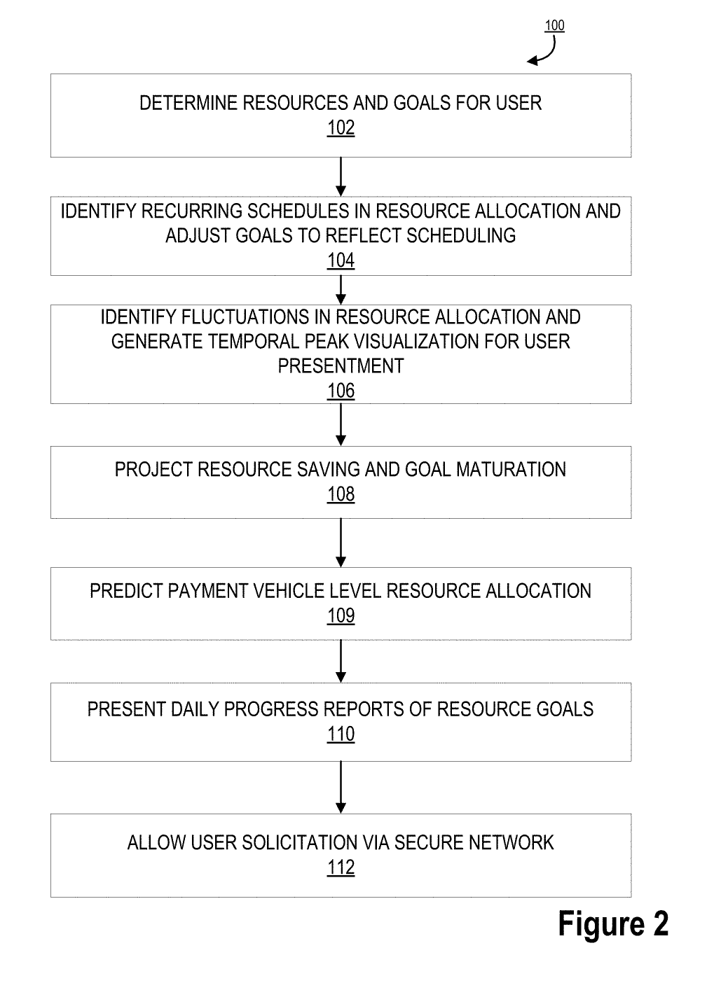

FIG. 2 provides a high level process flow illustrating the predictive utilization of resource process 100, in accordance with one embodiment of the present invention. As illustrated in block 102, the process 100 is initiated by determining resources and goals for the user. In some embodiments, determining resources includes determining funds, assets, and the like for the user as well as up to date real-time balances for the same. These resources may further include one or more accounts, funds, inflows, outflows, or the like. In some embodiments, determining balances includes the current balance of any resources that the user has. In some embodiments, the invention may also determine scheduled or recurring payments associated with the resources, includes identifying scheduled recurring payments that the user may have with one or more merchants, individuals, or the like.

In some embodiments, determining goals includes receiving and identifying savings and/or spending goals that a user may implement. In some embodiments, the system may receive goals in the way of products and/or services that the user may wish to purchase and a time frame associated with that purchase. In other embodiments, the system may identify goal purchases for a user based on user historical purchases, user social media interactions, or the like. For example, a system may identify that the user goes on vacation the same time of year on a recurring bases. This may be determined by the system based on transaction history, hotel reservation identification, fight reservation identification, or the like. Based on this, the system may set a goal of saving resources for a particular future time for a vacation.

As illustrated in block 104, the process 100 continues by identifying recurring schedules in resource allocation. Based on these identified recurring schedules, the system may adjust goal timing and savings to reflect the scheduling. In some embodiments, the system may identify recurring schedules in resource allocation based on an identification of a pattern in payment history from an account associated with a financial institution. As such, the system may recognize that a user uses an account at a financial institution to pay a specific merchant in a time interval. In other embodiments, the merchant may provide the system with information about recurring resource payments that one or more users send to the merchant. In yet other embodiments, the system may receive input from the user indicating recurring payments schedules for resources in the future. In some embodiments, the recurring schedules may be cyclical monthly expenses for the user. The system may extract data from financial institutions and identify patterns in payments from accounts of the user to one or more specific venders. These patterns may include cyclical payments to the same vendor, similar amounts of payments to the same vendor, or the like. In some embodiments, the system may, via communication linkage, communicate with the vendor directly in order to determine cyclical payments of a user.

Next, as illustrated in block 106, the process 100 continues by identifying fluctuations in resource allocation and generates temporal peak visualization for subsequent user presentment via the interface. In this way, the system may identify fluctuations in spending of resources within a time period, such as from day to day, month to month, year to year, or the like. The fluctuations may be any discrepancies in resource allocation from one time point to another, these may include small discrepancies in resource amount. Furthermore, the system may be able to identify when fluctuations include the movement of resources from one account to another or from one form to another, and not contribute those loss or gains in resources, thus account for the fluctuation and not include the fluctuations in the generated temporal peak visualization presentation on the interface. In some embodiments, any changes in resource levels for each individual account may be presented as a temporal peak within a graphical representation for user visualization of changes in resources over a given time period.

In some embodiments, the system may identify fluctuations based on user traveling. In this way, the system may identify expenses based on traveling and potentially identify reoccurring traveling on a weekly/monthly/yearly basis and incorporate these into resource allocation goals.

In some embodiments, the system may identify fluctuations in cyclical payments of resources and provide this fluctuation within a temporal peak graphical representation. As such, based on a comparison historic expenses and the current expenses for a particular product/service or vendor compared to the user's budget for that expense, the system may identify current expense level fluctuation or variation between the current expense and historic expenses to the budget. In this way, the fluctuation or variation between each payment of the cyclical payment may be tracked to identify the variations over a time frame. Furthermore, the fluctuation and/or variation between the cyclical payment and the user's budget for that payment may be tracked. Once the variations are identified over a time frame, the system may determine an average for the cyclical payments. Furthermore, the system may determine a termination period for the cyclical payments, such as a payoff point or the like associated with the cyclical payments.

As illustrated in block 108, the process continues by projecting resource savings and goal maturation. In this way, the system may review resource allocation and activity over a historic time period, dating as far back as resources are identified and associated with the user, to predict projected resource allocation for the user. In this way, the system may use learned pattern identification to identify resource allocations of the user over history. In this way, the system learns resource allocation and saving habits of the user and continues to apply those habits to future projections. As resources are continually fluctuating, the system may continue to learn current resource allocation habits of the user and apply a weighted scaled metric to the most recent allocation patterns and habits of the user, while still storing and recognizing historic allocation patterns in the projection process. In some embodiments, the system may generate a confidence rating associated with the projection based on the data the system may compile with respect to historic and recent resource allocating of the user.

Next, as illustrated in block 109, the process 100 continues by predicting payment vehicle level resource allocation. In this way, the system may granulize the projected resource saving and goal maturation determined in block 108 to the payment vehicle level. As such, the system may be able to identify and project each payment vehicle resource allocation in the future, thus predicting spend for each payment vehicle on an independent scale. Thus, they system may be able to allocate appropriate resource budgeting for each individual payment vehicle, identify a savings potential based on the use of an alternative payment vehicle, and/or identify one or more potential savings areas for goal progression.

As illustrated in block 110, the process 100 continues by presenting a daily progress report of resource goals. The daily progress report may be presented to the user via an interface. The interface may also comprise a temporal peak visualization of identified fluctuations in resource allocation, projected resource allocation, projected resource savings, projected goal maturation for resources, and payment vehicle level resource allocation. Each of these provided elements, may be selectable and interactive with the user via the user device. Upon user interaction with the element, the system may generate suggestions or recommendations for allocation of resources to improve the level of the element.

In this way, the interface may be generated and include utilized compiled data received from the user, financial institution, and vendor and convert the data extracted from the sources into a structured format for monitoring and implementation into the interface. In this way, the data may be converted into a textual format encrypted for security use for only the interface associated with the predictive utilization of resource system. Once the data is removed from the interface, the system encryption may prevent the data from being readable in any other medium.

Finally, as illustrated in block 112, the process 100 continues by allowing the user to communication with other individuals via a secure network for solicitation and goal maturation advice. In some embodiments, the user communication with other individuals comprises solicitation of goal aiding from other individuals. In this way, if a user is short resources for one or more of the daily goal presentations via the interface, the system may present other individuals for the user to communicate with and solicit from, in order to meet and/or reach the goal for the day. In other embodiments, the system may allow a user to communicate with other individuals for support and/or advice with respect to the daily goal progress report, the temporal peak visualization of identified fluctuations in resource allocation, the projected resource allocation, the projected resource savings, the projected goal maturation for resources, and/or the payment vehicle level resource allocation.

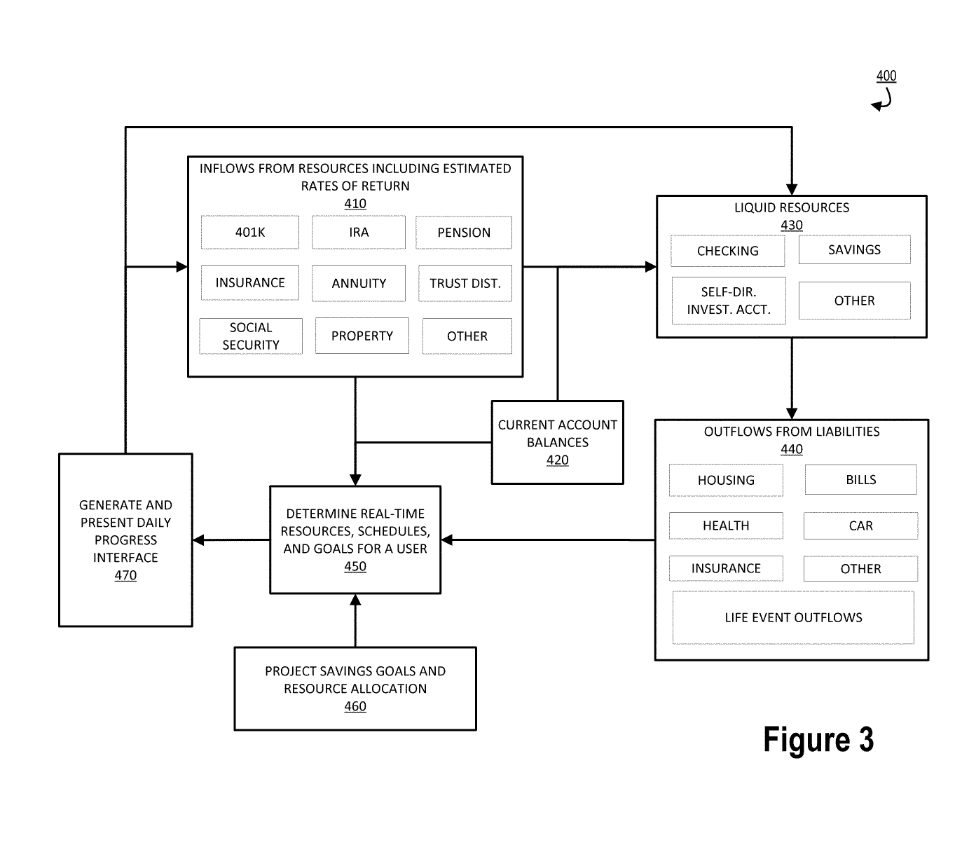

FIG. 3 illustrates a process map illustrating the real-time determination of resource availability process 400, in accordance with one embodiment of the present invention. Block 410 illustrates a number of resources, such as types of accounts, investments, annuities, property, or the like that may provide a stream of income (or negative steam of income) or payments over a period of time, but which may also be illiquid or otherwise difficult to convert into cash. For example, types of resources that provide disbursements may be a 401K that requires minimum disbursements to the user over a period of time at a specific age; an IRA that requires minimum disbursements to the user over a period of time at a specific age; a pension account that may provide disbursements until the user passes away; insurance benefits that may be distributed as an annuity for a period of time or as a lump sum; a trust account from which disbursement are made, property that provides rental income to the user, social security income or death benefits that pays disbursements for a period of time (e.g., a specific amount of time or for the life of a beneficiary), or other like annuity. In some embodiments of the invention the resources may include estimated rates of returns such that not only are the disbursements used in determining the available fund amount and/or age parameter, but the principal and growth of the principal over time may be used in determining the available fund amount and/or age parameter.

Block 430 illustrates liquid (e.g., liquid or semi-liquid) resources, such as accounts that may be equivalent to cash or resources that can be converted quickly into cash. For example, the liquid accounts may be checking accounts, savings accounts, self-directed investment accounts, money market accounts, or the like. These liquid accounts may be utilized to pay for the outflows directly. In some embodiments these types of accounts may be one of the last accounts that may be utilized to pay for outflows after the inflows from block 410 are exhausted (e.g., with the exception of lifetime annuity accounts). Some of these accounts may also have rates of return (e.g., savings accounts, self-directed investment accounts, or the like) which may be factored in when calculating the available fund amount and/or the age parameter.

As illustrated in block 440 the outflows of the users may include the payments that the user makes in order to live (e.g., necessary or semi-necessary to the user for the living expenses and other liabilities of the user). For example, in some embodiments the outflows may include housing outflows, which may cover the expenses of the user for house payments, taxes, insurance, or the like that the user has to pay in order to maintain a residence. In other examples, the outflows may be related to bills, such as electric, gas, water, or the like. The user's health care cost, such as user's health care premiums and yearly estimated cost may be included. The user may have car payments that are due on a monthly (or other time period) basis. The user may also have insurance payments for the user's car, life, or the like. In addition, there may be other outflows, such as but not limited to child care payments, cell phone payments, internet, and/or other entertainment expenses that may or may not be included in the outflow calculations (e.g., may or not be considered essentials or semi-essentials). The outflows may also include some life event outflows that may be easily predictable, non-repeating outflows, and/or only periodic outflows (e.g., occurs more than the time period for which the outflows are calculated), such as but not limited to paying for a child's college, paying for a wedding, or other like life events that affect the user's outflows. As illustrated by block 410 and 430 some of these outflows may be paid by one or more of the inflows, the supplemental employment income inflow, and/or the liquid resources either directly or indirectly. As such, one or more of the user's resources may have a balance that is depleted over time as the outflows are paid.

Block 420 illustrates a real-time current account balance for all resources available to the user based on the resources identified in block 410 and 430 and subtracted the up to the minute outflows from block 440.

It should be understood that the determination of the available fund amounts over the time period may change in real-time or near real-time as the rate of return on the resources change (e.g., stock values change, rental income changes or goes away, resources are depleted, big purchases are made or sold, or the like), and costs of the liabilities change (e.g., damage to property than needs repair, variable interest rate changes, life events occur that deplete resources, loans are taken out or paid off, or the like). As such, the present invention may be constantly in real-time or near real time, or over various intervals, recalculated in order to provide a more accurate available fund amount.

As illustrated in block 450, the process 400 continues by compiling the inflows 410, liquid resources 430, outflows 440, current balances 420, and projected savings goals and resource allocation 460 to determine real time resource levels, schedules, and goals for the user. In this way, the system may determine daily goal progress for presentation of an interactive report with the data from blocks 410, 430, 440, 420, and 460. Furthermore, in some embodiments, the system may generate a temporal peak visualization mapping of fluctuations identified in current resource allocation relative to previous resource allocation for the same or similar products/services. In some embodiments, the system may generate and project goal maturation for resources, and/or the payment vehicle level resource allocation.

In some embodiments, the system may project savings goals and projected resource allocation from block 460. In this way, the system may utilize the compiled data from blocks 410, 430, 440, and 420 and apply that data to learning technology to identify patterns in resource allocation of the user. These patterns may aid in the system development of a projected resource allocation for future allocation of resources of the user. The system may weigh the projection by applying more weight to more recent patterns identified from the data generated in blocks 410, 430, 440, and 420. As such, while all historic resource allocation data may be accessed and reviewed by the system, the most recent patterns may be attributed a weighted factor when determining projections of resource allocation.

Furthermore, the system may project savings goals in block 460. In this way, the system may analyze and review the data collected from blocks 410, 430, 440, and 420. The review of this data provides an indication of current savings of the user. Furthermore, based on resource allocation or lack of resource allocation to particular items, such as houses, cars, or the like may provide the system with a predicted goal that the user may be saving for. In some embodiments, the system may receive savings goals from the user. In some embodiments, the system may generate projected savings goals for the user based on age, current resource allocation, and the like.

Finally, as illustrated in block 470, the system may generate and present a daily progress interface to the user. The daily progress interface may be generated and automatically displayed on a user device at a specific time every day providing the use with a holistic predictive utilization of resources view along with alarms regarding resource allocation. The interface displaying may interfere with one or more other functions being performed on the mobile device at the predetermined time for display of the interface. In some embodiments, the interface may be presented as an overlay over an already displaying mobile device display. The interface may display, in a selectable format, the data from blocks 410, 430, 440, 420, and 406. Furthermore the interface may display a daily goal progression, temporal peak visualization of identified fluctuations in resource allocation, projected resource allocation, projected resource savings, projected goal maturation for resources, and/or payment vehicle level resource allocation. Finally, in some embodiments, the system may allow, via secure linkage, a user to communicate with other individuals with similar goals or resources for support and/or advice with respect to the daily goal progress report.

As such, the system presents the user with a real-time illustration of resource allocation and goal implications based on adjustments to spending and/or savings. The interface may appear via overlay on a mobile device screen such as during a web session, texting session, telephone session, gaming session, or the like being conducted on the mobile device. Thus, the interface may displace one or more portions of the web session on the display, as such manipulating the physical position of the displaying of the web session, text session, telephone session or the like such that the interface may be displayed and visualized as an overlay.

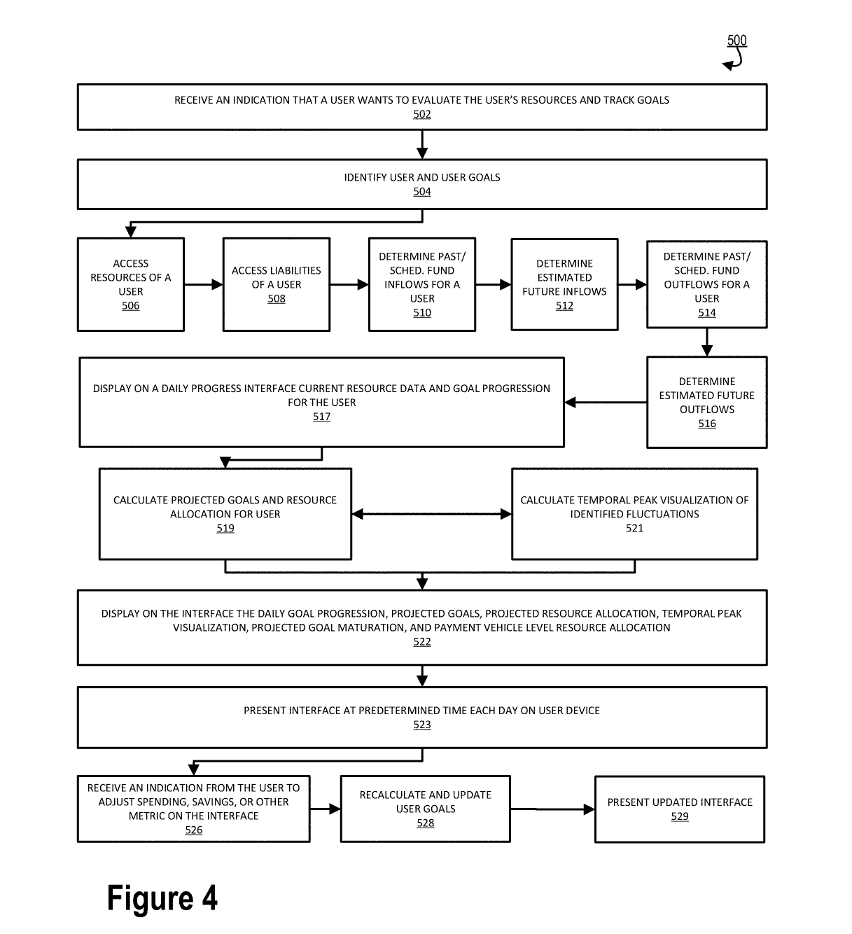

FIG. 4 illustrates a process map for the real-time determination of resource availability process 500, in accordance with one embodiment of the present invention. As illustrated by block 502, the system receives an indication that a user wants to evaluate his/her resources and track resource goals. For example, the user may desire a real-time view of all resources available to the user. In another example, the user may desire to manipulate his/her resources and distribute the resources to various other accounts or the like. In some embodiments, the user may desire to track and progress towards goal purchases of products or services.

As illustrated by block 504, the system may identify the user and user goals. As such, the system may identify authorization information from the user to access one or more accounts associated with resources. Once the user has been authenticated and the user information has been identified, the system may access real-time information about each of the user's resources. Furthermore, the system may request resource goal information from the user. As such, the system may request information about goals of products or services the user may wish to purchase, savings goals, and time frames associated with each goal. In this way, the system may be able to identify goals of the user and allocate resources in order to reach those goals.

Block 506 illustrates that the system may access the resources of the user (e.g., the resources described with respect to blocks 410 and 430 in FIG. 3). For example, the system accesses resource information from the user's accounts that a financial institution services. In this way, the system may utilize the authorization information provided from the user to access, via web portals, the resource activity. In other embodiments, the system may contact one or more financial institutions or entities holding user resources to request and obtain access to the resource information. The user may also allow the system to access the user's accounts with other third-parties and/or financial institutions. Moreover, the system may evaluate other resources that the system knows that the user owns, such as for example the system has information about the property that the user's own, and thus can evaluate the value of the resource and/or the future value over of the resource over time.

As illustrated in block 508 the system accesses the liabilities of the user (e.g., the liabilities described with respect to block 440 in FIG. 3). For example, the system accesses liability information from the user's accounts that a financial institution services. The user may also allow the system to access the user's accounts with other third-party financial institutions (e.g., first mortgage, second mortgage, or the like). As such, the system may evaluate the liabilities that the user has that may affect the forecast planning of the user.

It should be understood that with respect to blocks 506 and 508, as well as otherwise described herein, in some embodiments of the invention the current and/or future fair market value of the resources or liabilities may be determined by accessing third-party servers, systems, devices, applications, or the like in order to determine the fair market values. For example, the system may access websites that provide estimates of home values, car values, antique values, or the like.

Block 510 illustrates that the system determines the past/future fund inflows for the user. For example, the system can determine the amount of funds that the user has received from various accounts within and outside of a financial institution over time. With respect to the accounts serviced by a financial institution the system may access to the past/future fund inflows. With respect to accounts located outside a financial institution the past fund inflows may be determined by identifying the inflow of funds into the accounts held by a financial institution. Moreover, as previously discussed the user may allow the system to access the user's accounts to determine any past/future funds that the user may receive from various resources. Moreover, the system may determine the resources of the user that have yet to provide inflows (e.g., 401k accounts that cannot be accessed until a specific age, or the like). In some embodiments the system may estimate the future inflow of funds, for example, if the user receives the same payments continuously in consecutive time periods the system may continue to estimate the same fund receipts in future time periods.

In some embodiments, the user may have resources that only the user is aware of, and as such the user may provide an indication of the unidentified resources to the system to include in the calculation of the user's resources and/or fund in-flows for the forecast interface. In some embodiments the unidentified resources may include money being paid back for a loan provided by the user that the system does know about, the user is a beneficiary of an account that the system does not know about, the user is a silent partner in business that the system does not know about, or the like.

In some embodiments, the system may analyze the outflows in order to determine what may qualify as an outflow that is necessary (e.g., necessary or semi-necessary to cover cost of living expenses), such as mortgages, heat, water, gas, phone, internet, or the like, from any discretionary spending that may cover payments the user may make for entertainment (e.g., trips, dinner out, movies, shows, presents, or the like), such as payments that would be covered by the calculated available fund amount. As such, the transactions made by the user that may be discretionary may be utilized to determine an estimated available fund amount that the user is currently spending, which may be augmented by inflation rates in order to determine what the available fund amount may be in the future. As such, the available fund amount may be set in order to determine what the user likely wants to have available to the user in the future.

Block 512 illustrates that the system determines the estimated future inflows that the user receives based on the past inflows and future inflows determined from block 510. The system may determine the estimated inflows that the user may receive (e.g., may decide to receive, may be required to receive based on applicable laws, or the like) in the future. The estimated inflows may be averaged over a one or more time periods (e.g., short term, long term, or the like), may be determined for one or more time periods, or may be determine until reaching the age parameter. In some embodiments, the estimated future inflows may be based on a user mock movement of resources from one account to another. In this way, the system may determine the impact of a movement of resources on the other resources associated with the user.

Block 514 illustrates that the system determines the past and future scheduled fund outflows for the user. For example, the system can determine the amount of funds that user has paid from various accounts within and outside of a financial institution over time to a specific vendor or on a cyclical pattern. In this way, the system may identify monthly expenses for the user. The system may first identify cyclical monthly expenses for the user. The system may extract data from financial institutions and identify patterns in payments from accounts of the user to one or more specific venders. These patterns may include cyclical payments to the same vendor, similar amounts of payments to the same vendor, or the like. In some embodiments, the system may, via communication linkage, communicate with the vendor directly in order to determine cyclical payments of a user.

Based on the identified monthly expenses, the system may parsing out the monthly expenses for a granular view of the individual payment from the user. In this way, the system may parse out the identified monthly expenses to a granular level, such that the date, time, product/service, amount, and merchant for each payment identified is revealed. In this way, the system may utilize and compile data received from the user, financial institution, and vendor in order to identify the date, time, product/service, amount, and merchant for each identified cyclic expense.

The system may access to the past/future fund outflows by examining the payments that the user has made over time (e.g., in the past) and/or has scheduled in the future. This may be performed by accessing a financial institution system or via system authorization for access to the resources of the user based on user provided authorization credentials. In some embodiments the system may estimate the future outflow of funds, for example, if the user makes the same payments continuously in consecutive time periods the system may continue to estimate the same payment in future time periods. For example, the system can determine the amount of funds that the user has sent for payment from various accounts within and outside of a financial institution over time. Moreover, the system may determine the liabilities of the user that have yet to provide outflows (e.g., annuity payments that the user may make in the future, payments scheduled for a trust account, payments to fund a future resource purchase, or the like). In some embodiments the system may estimate the future outflow of funds, for example, if the user makes the same payments continuously in consecutive time periods the system may continue to estimate the same payments in future time periods.

In some embodiments, the user may have liabilities that only the user is aware of, and as such the user may provide an indication of the unidentified liabilities to the system to include in the system's calculation of the user's liabilities and/or fund out-flows. In some embodiments the unidentified liabilities may include money the user is paying back for a loan provided to the user (e.g., loan from a family member or friend, or the like) that the system does know about, the user is supporting a dependent that the financial institution does not know about, the user is a silent partner in business that the system does not know about, or the like.

Block 516 illustrates that the system determines the estimated future outflows that the user pays based on the past outflows and future outflows. The system may determine the estimated outflows that the user may pay (e.g., may decide to pay, may be required to pay based on applicable laws, payments made to cover liabilities, or the like) in the future. The estimated outflows may be averaged over a one or more time periods (e.g., short term, long term, or the like), may be determined for one or more time periods, or may be determine until reaching a user specified age parameter.

Next, as illustrated in block 517, the system may display on an interface, the goal progress for the user and a real-time current resource view of all user resources. As such, the system may convert data extracted from the sources in blocks 506, 508, 510, 512, 514, and 516 into a structured format for monitoring and implementation into the interface. In this way, the data may be converted into a textual format encrypted for security use for only the interface. Once the data is removed from the interface, the system encryption may prevent the data from being readable in any other medium.

As illustrated in block 519, the system may calculate projected goals and future resource allocation for the user. In this way, the system may utilize the compiled data and apply that data to learning technology to identify patterns in resource allocation of the user. These patterns may aid in the system development of a projected resource allocation for future allocation of resources of the user. The system may weigh the projection by applying more weight to more recent patterns identified from the data generated. As such, while all historic resource allocation data may be accessed and reviewed by the system, the most recent patterns may be attributed a weighted factor when determining projections of resource allocation.

Furthermore, the system may project savings goals. In this way, the system may analyze and review the data collected. The review of this data provides an indication of current savings of the user. Furthermore, based on resource allocation or lack of resource allocation to particular items, such as houses, cars, or the like may provide the system with a predicted goal that the user may be saving for. In some embodiments, the system may receive savings goals from the user. In some embodiments, the system may generate projected savings goals for the user based on age, current resource allocation, and the like.

As illustrated in block 521, the process 500 continues by calculating temporal peak visualization of identified fluctuations in resource allocation. In this way, the system may identify fluctuations from time frame to time frame based on the identified resources from blocks 506, 508, 510, 512, 514, and 516. As such, the system may identify fluctuations in spending of resources within a time period, such as from day to day, month to month, year to year, or the like. The fluctuations may be any discrepancies in resource allocation from one time point to another, these may include small discrepancies in resource amount. Furthermore, the system may be able to identify when fluctuations include the movement of resources from one account to another or from one form to another, and not contribute those loss or gains in resources, thus account for the fluctuation and not include the fluctuations in the generated temporal peak visualization presentation on the interface. In some embodiments, any changes in resource levels for each individual account may be presented as a temporal peak within a graphical representation for user visualization of changes in resources over a given time period.

In some embodiments, the system may base fluctuation determination on a comparison historic expenses with the current expenses for a particular product/service or vendor compared to the user's budget for that expense. In this way, the fluctuation or variation between each payment may be tracked to identify the variations over a time frame. Furthermore, the fluctuation and/or variation between the cyclical payment and the user's budget for that payment may also be tracked.

Next, as illustrated in block 522, the system may display on the interface, the daily goal progression for the user, projected goals and maturation of those goals, projected resource allocation, temporal peak visualization, and payment vehicle granular level resource allocation. The interface may appear via overlay on a mobile device screen such as during a web session, texting session, telephone session, gaming session, or the like being conducted on the mobile device. Thus, the interface may displace one or more portions of the web session on the display, as such manipulating the physical position of the displaying of the web session, text session, telephone session or the like such that the interface may be displayed and visualized as an overlay. As illustrated in block 523, the system may present the interface on the display of the mobile device at a predetermined time each day for user visualization and alerting.

As illustrated in block 526, the system, via the interface may receive an indication from the user to adjust spending, saving, or other illustrated metrics on the interface. In some embodiments, the user may be preparing for a large purchase, thus wishing to change his/her goals and adjust resource allocation. In other embodiments, the adjustment may reflect an actual move of resources, such as a purchase or reallocation of resources to one or more alternative sources.

As illustrated in block 528, the system may recalculate and update the user goals based on the adjustments from block 526. Finally, the system may present the user with the updated interface which includes the updated goals, as illustrated in block 529.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 6961US1.014033.2579 | To be assigned | RESOURCE OPTIMIZATION | Concurrently |
| | | ALLOCATION SYSTEM | herewith |
| 6960US1.014033.2580 | To be assigned | RESOURCE ALLOCATION | Concurrently |
| | | BASED ON AVAILABLE | herewith |
| | | RESOURCES VIA INTERACTIVE | |
| | | INTERFACE | |
| 6907US1.014033.2582 | To be assigned | REAL TIME RESOURCE | Concurrently |
| | | TRACKING AND ALLOCATION | herewith |
| | | SYSTEM | |
| 6906US1.014033.2583 | To be assigned | REAL TIME DETERMINATION | Concurrently |
| | | OF RESOURCE AVAILABILITY | herewith |
| | | FOR USAGE | |
| 6963US1.014033.2584 | To be assigned | REALLOCATION OF | Concurrently |
| | | RESOURCES SYSTEM | herewith |

What is claimed is:

1. A system for predictive utilization of resources, the system comprising:
a memory device with computer-readable program code stored thereon;
a communication device;
a processing device operatively coupled to the memory device and the communication device, wherein the processing device is configured to execute the computer-readable program code to:
determine resources available to a user;
receive authorization credentials from the user to access the resources;
extract resource data from a source of each resource available to the user, wherein the resource data includes historic resource allocation, real-time resource balances, and recurring expenses for the resources;
convert the extracted resource data into a textual format encrypted for implementation on an interface;
determine resource goals for the user based on the extracted resource data and user input data;
identify fluctuations in resource allocation based on the extracted resource data and generate a temporal peak visualization representation of the fluctuations;
project, based on the historic resource allocation, the real-time resource balances, and the recurring expenses for the resources, resource savings, and goal maturation points;
generate the interface for presenting daily goal progression; and
present, at a predetermined time each day, the interface, wherein the interface presents goal progression, a graphical representation of the fluctuations via the temporal peak visualization representation, the projected resource savings, and the projected goal maturation.

2. The system of claim 1, further comprising generating a payment vehicle level resource allocation directive for a future time period based on the resource goals relative to the recurring expenses and real-time resource balances.

3. The system of claim 1, wherein identifying fluctuations in resource allocation based on the extracted resource data further comprises identifying differences between a historic resource allocation to an entity and a current resource allocation to the entity within a month to month or year to year time frame.

4. The system of claim 1, wherein presenting the interface further comprises presenting the interface via an overlay on a screen of the mobile device such that the interface displaces one or more portions of a session on the display, whereby manipulating the physical position of the displaying of the session.

5. The system of claim 4, wherein the one or more portions of a session on the display further comprises a web session, text session, or telephone session of the user on the mobile device.

6. The system of claim 1, wherein converting the extracted resource data into a textual format encrypted for use on the interface further includes preventing the data from being readable in any medium other than the interface if data is removed from the interactive forecast interface.

7. The system of claim 1, wherein resources comprise financial resources of the user.

8. A computer program product for predictive utilization of resources, the computer program product comprising at least one non-transitory computer-readable medium having computer-readable program code portions embodied therein, the computer-readable program code portions comprising:
an executable portion configured for determining resources available to a user;
an executable portion configured for receiving authorization credentials from the user to access the resources;
an executable portion configured for extracting resource data from a source of each resource available to the user, wherein the resource data includes historic resource allocation, real-time resource balances, and recurring expenses for the resources;
an executable portion configured for converting the extracted resource data into a textual format encrypted for implementation on an interface;
an executable portion configured for determining resource goals for the user based on the extracted resource data and user input data;
an executable portion configured for identifying fluctuations in resource allocation based on the extracted resource data and generate a temporal peak visualization representation of the fluctuations;
an executable portion configured for projecting, based on the historic resource allocation, the real-time resource balances, and the recurring expenses for the resources, resource savings, and goal maturation points; generating the interface for presenting daily goal progression; and
an executable portion configured for presenting, at a predetermined time each day, the interface, wherein the interface presents goal progression, a graphical representation of the fluctuations via the temporal peak visualization representation, the projected resource savings, and the projected goal maturation.

9. The computer program product of claim 8, further comprising an executable portion configured for generating a payment vehicle level resource allocation directive for a future time period based on the resource goals relative to the recurring expenses and real-time resource balances.

10. The computer program product of claim 8, wherein identifying fluctuations in resource allocation based on the extracted resource data further comprises identifying differences between a historic resource allocation to an entity and a current resource allocation to the entity within a month to month or year to year time frame.

11. The computer program product of claim 8, wherein presenting the interface further comprises presenting the interface via an overlay on a screen of the mobile device such that the interface displaces one or more portions of a session on the display, whereby manipulating the physical position of the displaying of the session.

12. The computer program product of claim 11, wherein the one or more portions of a session on the display further comprises a web session, text session, or telephone session of the user on the mobile device.

13. The computer program product of claim 8, wherein converting the extracted resource data into a textual format encrypted for use on the interface further includes preventing the data from being readable in any medium other than the interface if data is removed from the interactive forecast interface.

14. The computer program product of claim 8, wherein resources comprise financial resources of the user.

15. A computer-implemented method for predictive utilization of resources, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
determining resources available to a user;
receiving authorization credentials from the user to access the resources;
extracting resource data from a source of each resource available to the user, wherein the resource data includes historic resource allocation, real-time resource balances, and recurring expenses for the resources;
converting the extracted resource data into a textual format encrypted for implementation on an interface;
determining resource goals for the user based on the extracted resource data and user input data;
identifying fluctuations in resource allocation based on the extracted resource data and generate a temporal peak visualization representation of the fluctuations;
projecting, based on the historic resource allocation, the real-time resource balances, and the recurring expenses for the resources, resource savings, and goal maturation points;
generating the interface for presenting daily goal progression; and
presenting, at a predetermined time each day, the interface, wherein the interface presents goal progression, a graphical representation of the fluctuations via the temporal peak visualization representation, the projected resource savings, and the projected goal maturation.

16. The computer-implemented method of claim 15, further comprising generating a payment vehicle level resource allocation directive for a future time period based on the resource goals relative to the recurring expenses and real-time resource balances.

17. The computer-implemented method of claim 15, wherein identifying fluctuations in resource allocation based on the extracted resource data further comprises identifying differences between a historic resource allocation to an entity and a current resource allocation to the entity within a month to month or year to year time frame.

18. The computer-implemented method of claim 15, wherein presenting the interface further comprises presenting the interface via an overlay on a screen of the mobile device such that the interface displaces one or more portions of a session on the display, whereby manipulating the physical position of the displaying of the session.

19. The computer-implemented method of claim 18, wherein the one or more portions of a session on the display further comprises a web session, text session, or telephone session of the user on the mobile device.

20. The computer-implemented method of claim 15, wherein converting the extracted resource data into a textual format encrypted for use on the interface further includes preventing the data from being readable in any medium other than the interface if data is removed from the interactive forecast interface.
